(19) United States
(12) Patent Application Publication
(10) Pub. No.: US 2018/0313732 A1
(43) Pub. Date: Nov. 1, 2018

(54) METHOD AND APPARATUS FOR A HARDNESS TEST BLOCK ALIGNMENT

(71) Applicants: Giancarlo Mazzoleni, Philadelphia, PA (US); William P. Daley, Schwenksville, PA (US)

(72) Inventors: Giancarlo Mazzoleni, Philadelphia, PA (US); William P. Daley, Schwenksville, PA (US)

(21) Appl. No.: 15/942,883

(22) Filed: Apr. 2, 2018

Related U.S. Application Data
(60) Provisional application No. 62/492,362, filed on May 1, 2017.

(51) Int. Cl. G01N 3/62; G01N 3/42

(52) U.S. Cl. CPC G01N 3/62; G01N 3/42; G01N 2203/0019; G01N 2203/0206; G01N 2203/0405

(57) ABSTRACT

A combination of a unique test block and a modification of the anvil on a hardness testing machine wherein the combination enables the testing block to easily and quickly align with the indenter of the hardness testing when said testing block is placed on the hardness testing machine's anvil. At least one spring-loaded ball detent is provided that enables the test block to be positioned using one of a plurality of dimples on said testing block. A cradle is provided when a double-sided test block is used to keep the surface of the test block from being marred when said testing block is placed on the anvil. An alternative embodiment uses more than one detent on the anvil which keeps the test block from rotating while the test block is on the anvil.

This application claims benefit of U.S. Provisional Application Ser. No. 62/492,362 filed May 1, 2017, pursuant to 35 USC § 119(e).

### FIELD OF THE INVENTION

This invention relates to hardness testing equipment and methods, in particular, alignment of test sites on test blocks for guaranteeing proper spacing of indentations on the test block during calibration of hardness testers.

### BACKGROUND OF THE INVENTION

Indentation testing is very widely used in the industry for the determination of metal hardness. Hardness is a characteristic of a material, not a fundamental physical property. It is defined as the resistance to indentation and it is determined by measuring the permanent depth of the indentation or its diameter. That is, when using a fixed force (load) on a particular indenter, the smaller the indentation, the harder the material.

Indentation hardness value is obtained by measuring the depth or the area of the indentation using one of over 12 different test methods such as ASTM standards E10, E18, E110, E103, E92, and E384 as well as the corresponding ISO Standards 6506, 6507, and 6508.

One of the most common methods of determining hardness is the Brinell hardness test method as defined in ASTM E10. Typically, it is used to test materials having a structure that is too coarse or that have a surface that is too rough to be tested using another test methods. Brinell testing often uses a very high test load (3000 kgf) and a 10 mm diameter indenter so that the resulting indentation averages out most surface and sub-surface inconsistencies.

The Brinell method applies a predetermined test load (F) to a hard steel or carbide ball of fixed diameter (D), which is held for a predetermined time period and then, removed. The resulting impression is measured across at least two diameters—usually at right angles to each other and the result is averaged. A chart is then used to convert the averaged diameter measurement to a Brinell hardness number. Test forces range from 1 to 3000 kgf.

A Brinell hardness result measures the permanent diameter of the indentation produced by a hard steel or carbide indenter applied to a test specimen at a given load, for a given length of time. Typically, an indentation is made with a Brinell hardness testing machine and then measured for indentation diameter in a second step with a specially designed Brinell microscope. The resulting measurement is converted to a Brinell value using the Brinell formula or a conversion chart based on the formula.

Most typically, a Brinell test will use 3000 kgf load with a 10 mm ball. If the sample material is aluminum, the test is most frequently performed with a 500 kgf load and a 10mm ball. Brinell test loads can range from 3000 kgf down to 1 kgf. Diameters of the indenter ball can range from 10 mm to 1 mm. Generally, the lower loads and ball diameters are used for convenience in “combination” testers, like Rockwell units, that have a small load capacity.

The test standard specifies a time of 10 to 15 seconds, although shorter times can be used if it is known that the shorter time does not affect the result. There are other conditions that must be met for testing on a round specimen, such as spacing of indentations, minimum thickness of test specimens, etc.

Common to all of these hardness testing methods and hardness testing equipment is the use of testing blocks, such as Rockwell, Brinell, Vickers and Knoop. These test blocks come in different sizes and materials depending on the hardness of the material and surface configurations of the material that is to be tested.

The material that makes up these test blocks must be uniform throughout in order to meet the strict repeatability requirements of the ASTM standards. Therefore, the cost of the material per indentation allowed is a large component of the total cost of producing these test blocks. Further, the larger the indentation for each test performed, the lower the number of tests that can be done on a particular sized block. The expected indentation size corresponds to the hardness of the material of the test block; harder material yields smaller indentations. The indentation sizes for 3000 kgf test force and a 10 mm diameter indenter ranges from 2.4 to 6.0 mm.

As disclosed and claimed in U.S. patent application Ser. No. 15/407,559, filed by Mazzoleni et al. on Jan. 17, 2017, a method and apparatus for increasing the number of test sites per test block is provided. This application is hereby incorporated in its entirety into this application.

These standardized test blocks are used to verify that the testing equipment, test methods and operator is performing within the required parameters.

There are several issues with the current test blocks being offered. As noted above, the number of test sites per block is limited due to the spacing requirements. While test blocks are typically laid out with a grid pattern to indicate the proper spacing and location of the test sites, if an operator fails to properly line up the indentation with the center of the grid, even by a small amount, the spacing between subsequent tests cannot be maintained and even less tests can be utilized.

Frequently, in aerospace operations as well as other critical performance situations, it is often vital to be able to re-measure one or more of the indentations to verify the results. This is difficult when using current methods.

Finally, there is no method for optimizing the test site patterns on a given size of a test block for a particular indentation size (corresponding to a particular hardness). With the current grid imprinting available on some test blocks, it is still possible to place indentation inside the marked area and still not meet the spacing requirements. Further, the test block must be placed on the machine anvil accurately and quickly to ensure that the indentations made on the test block by the machine indenter are properly spaced.

### SUMMARY OF THE INVENTION

It is an aspect of the invention to provide a hardness test block wherein the number of test sites is optimized for a given test block size and a hardness being tested.

It is another aspect of the invention to provide a hardness test block having an alignment template and/or cradle that enables an operator to be assured of having the test block grid pattern aligned properly with the indenter of a hardness testing machine.

Another aspect of the invention is to provide a cradle for a test block so that the primary test surface as well as the opposite surface can both be used for testing purposes such that the cradle protects the test surface from being contacted by the anvil of the hardness testing machine during the test operation.

Finally, another aspect of the invention is to provide a test block having a plurality of dimples or indentations on the surface opposite the test surface when the single-sided test block is used or a cradle with dimples is provided when a double-sided test block is used, such that the ball of a spring-loaded ball detent engages a dimple thus, ensuring easy and quick alignment of the test block and machine indenter using the dimples and the detent.

### BRIEF DESCRIPTION OF THE DRAWINGS

FIG. 1A is front view of a test block with a plurality of dimples in a typical test block wherein a spring-loaded detent in an anvil of a typical hardness test machine can be used to align the test block with the indenter of the hardness test machine.

FIG. 1B is a top view of the test block shown in FIG. 1A.

FIG. 2A is a front view with a double-sided test block being supported by a cradle, which is provided with a plurality of dimples for alignment with a detent in the anvil of a typical hardness test machine.

FIG. 2B is a top view of the test block shown in FIG. 2A.

FIG. 3A is an alternative embodiment of the invention showing a front view of a plurality of detents in the anvil of a typical hardness test machine.

FIG. 3B is a top view of the alternative embodiment shown in FIG. 3A.

FIG. 4 is an exploded isometric view of a test block and a supporting cradle.

### DETAILED DESCRIPTION OF THE INVENTION

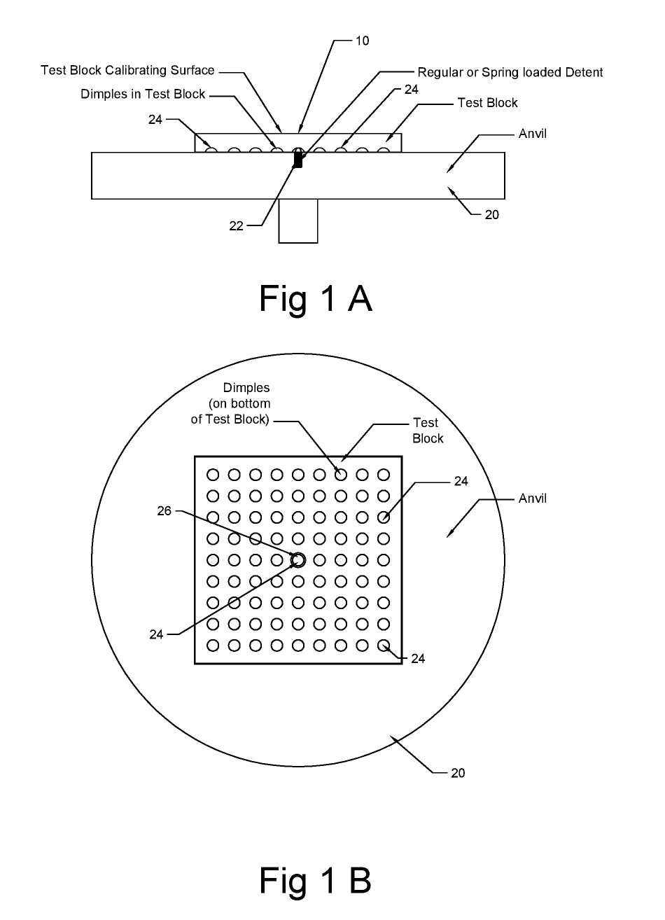

While the test block used in the invention is preferably the type disclosed and claimed in U.S. patent application Ser. No. 15/407,559, the techniques and methods used herein can be applied to any test block as shown in FIG. 1.

Shown in FIG. 1, a plurality of dimples 24 is provided in the bottom surface of test block 10, which rests on anvil 20. The plurality of dimples 24 is aligned with the predetermined test sites on the opposite side of test block 10.

Dimples 24 can be placed so that the centers of the dimples 24 are coincident with the centers of test sites 26 as shown in the accompanying figures. Also, dimples 24 can be aligned so that they fall between the centers of the test sites (not shown).

Detent 22 which can be spring-loaded is set in the center surface of anvil 20 of a typical hardness test machine (Not Shown) which is well known in the art. If the centers of dimples 24 are spaced between the centers of test sites 26, then the position of detent 22 must be offset accordingly so that when detent 22 engages one of dimples 24, the center of test site 26 being used is aligned perfectly with the indenter of the hardness test machine. In this manner, when detent 22 engages one dimple 24, test block 10 is properly aligned with the appropriate test site 26 as shown.

While test site 26 is shown as having a greater diameter than dimple 24, this is not necessary, and it could be just the opposite. Also, test sites 26 could be marked with indicia identifying the test sites and marked or etched on test block 10, which will facilitate ease of aligning a particular dimple 24 with detent 22.

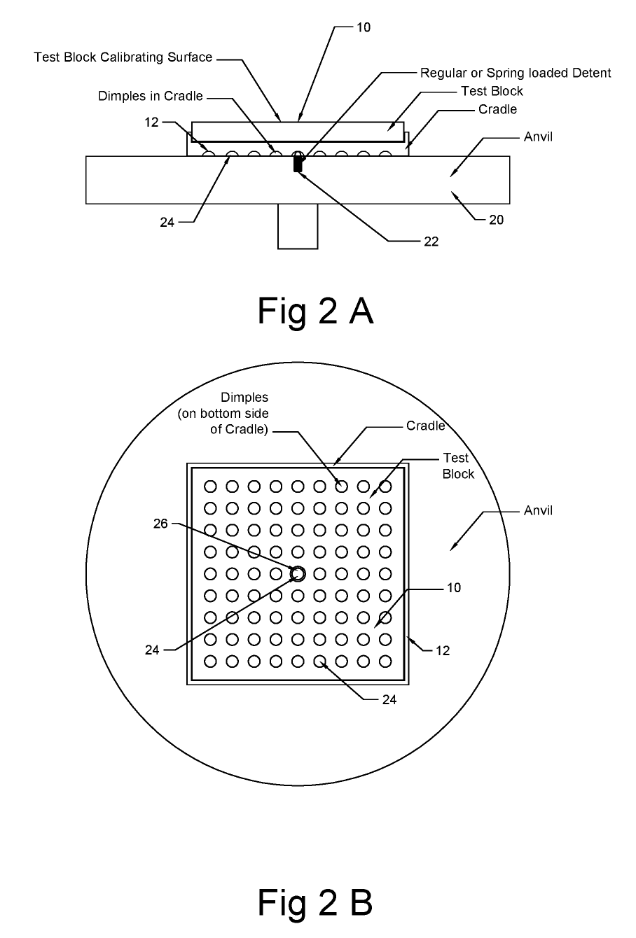

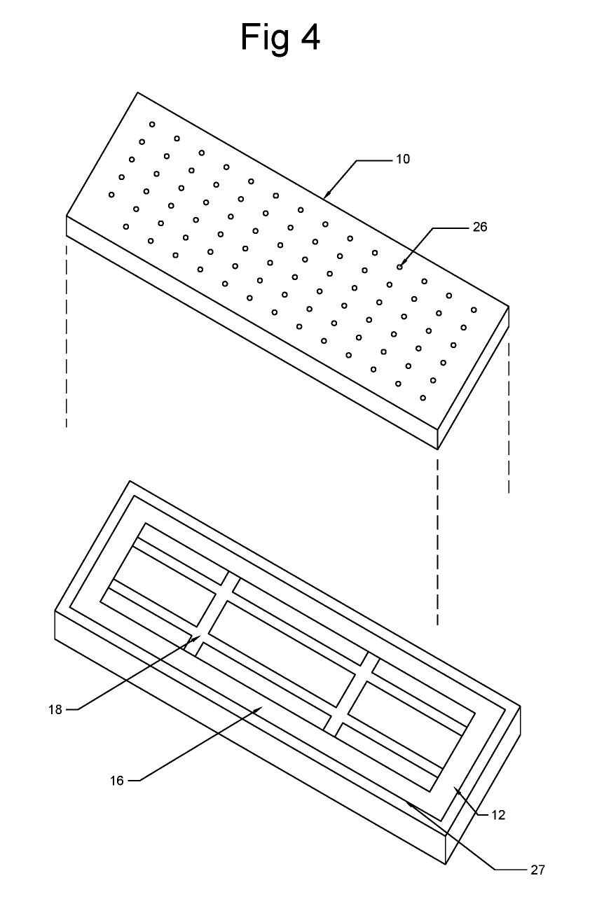

If a double-sided test block 10 is used in accordance with the teachings of U.S. patent application Ser. No. 15/407,559, then cradle 12 should be used to keep the non-test side of test block 10 from contacting anvil 20 during the testing process. This is necessary to prevent any marring of the non-tested surface, which would prevent both sides of test block 10 from being used. This is shown in FIGS. 2 and 4. Note that when using a double-sided test block, dimples are not provided in the test block, as this would interfere with proper testing on both sides of the block.

Cross members 18 of cradle 12 hold the test surface away from anvil 20 while the opposite surface is being used. Recess 27 is provided in cradle 12 so that test block 10 is securely held in position while being supported as shown in FIGS. 2, 3, and 4. While two cross members 18 are shown, more or less could be used, again depending on the configuration of test block 10 and the expected forces that will be applied to test block 10. Cradle 12 could also be round when used with round test blocks.

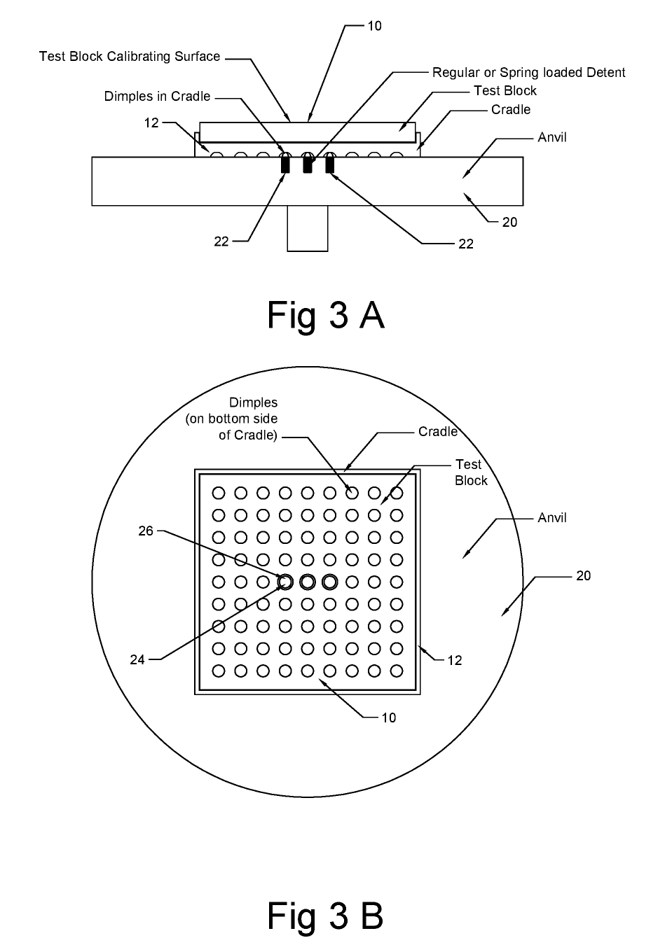

An alternative embodiment of the invention is depicted in FIG. 3 shown with a double-sided test block. While a single detent 22 would position test site 26 properly aligned with the indenter of the test machine when the centers of dimples 24 are coincident with centers of test sites 26, this might not be the case when dimples 24 are offset from the centers of test sites 26 since test block 10 (or when in cradle 12) is free to rotate around a single detent 22. Therefore, by the addition of one or more detents 22 as shown in FIG. 3, test block 10 (or when in cradle 12) is locked into position and can no longer rotate.

Although the present invention has been described with reference to certain preferred embodiments thereof, other versions are readily apparent to those of ordinary skill in the preferred embodiments contained herein.

What is claimed is:

1. A combination of a hardness test bock and a hardness testing apparatus having an anvil, an indenter that is adapted to produce a preselected force for a predetermined period of time on a test site wherein said combination comprises:
the test block having a plurality of test sites on one side of said hardness test block forming a grid pattern and a plurality of dimples on the opposite side of said hardness test block wherein each dimple is directly opposite to and aligned with one of said plurality test sites on said grid pattern;
the anvil of the hardness testing apparatus comprising at least one spring-loaded ball detent aligned with the indenter of the hardness testing apparatus such that when said detent engages with one dimple on said hardness test block, the test site corresponding to that dimple is positioned beneath the indenter and aligns the grid pattern of the test block with the hardness testing apparatus quickly and accurately.

2. A combination of a hardness test bock, a cradle, and a hardness testing apparatus having an anvil, an indenter that is adapted to produce a preselected force for a predetermined period of time on a test site wherein said combination comprises:
a test block having a plurality of test sites on one side of said hardness test block forming a first grid pattern and a plurality of test sites on the other side of other side of said test block forming a second grid pattern;
the cradle dimensioned to hold the test block wherein said cradle further comprises a plurality of dimples on the side of the cradle that is adjacent to the anvil of the testing apparatus such that each dimple's position aligns with the center of a corresponding test site grid such that the indenter is centered within the test site;
the anvil of the hardness testing apparatus comprising at least one spring-loaded detent aligned with the indenter of the hardness testing apparatus such that when said detent engages with one dimple on said cradle, the test site corresponding to that dimple is positioned beneath the indenter and aligns the grid pattern of the test block with the hardness testing apparatus quickly and accurately and the use of the cradle prevents the test sites from contacting the anvil during the testing operation thus preventing marring of the testing surfaces.

3. The combination of claim 1 wherein at least two spring-loaded ball detents are provided such that the test block is prevented from rotating when the at least two detents are engaged in the least two dimples in the test block.

4. The combination of claim 2 wherein at least two-loaded detents are provided such that the cradle with the test block inserted therein is prevented from rotating when the at least two detents are engaged in the at least two dimples in the cradle.
